(19) United States
(12) Patent Application Publication
(10) Pub. No.: US 2003/0069790 A1
(43) Pub. Date: Apr. 10, 2003

(54) Network assisted advertising

(76) Inventor: Roger A. Kane, Alpharetta, GA (US)

Correspondence Address: OLIFF & BERRIDGE, PLC, P.O. BOX 19928, ALEXANDRIA, VA, 22320, US

(21) Appl. No.: 09/985,418

(22) Filed: Nov. 2, 2001

Related U.S. Application Data
(60) Provisional application No. 60/326,723, filed on Oct. 4, 2001.

(51) Int. Cl. G06F 17/60

(52) U.S. Cl. 705/14; 705/10

(57) ABSTRACT

This invention provides a network assisted advertising system where a subscriber may coordinate advertising channels such as newspapers, magazines, radio, television, etc. together with one or more websites of a network such as the Internet. The subscriber is provided tools in a web-based advertising system to construct, maintain and monitor one or more subscriber websites which may include text and photographs. The subscriber is given an access address for each subscriber website for use with other advertising channels. The access address is limited to be less than a predetermined number of characters. When the access address is used by a prospective customer, the web-based advertising system activates the subscriber website. The web-based advertising system protects the subscriber's advertising investment by not providing search tools that may produce other subscriber websites not explicitly linked by the subscriber.

This non-provisional application claims the benefit of U.S. Provisional Application No. 60/326,723 entitled “Network Assisted Advertising” filed on Oct. 4, 2001. The Applicant of the provision application is Roger Kane (Attorney Docket No. 109456). The above provisional application is hereby incorporated by reference including all references cited therein.

### BACKGROUND OF THE INVENTION

1. Field of Invention

The invention relates to network assisted advertising.

2. Description of Related Art

Advertising channels have been advanced by the steady increase of technology. For example, the Internet provides a medium in which information may be deposited so that easy and ready access may be provided to a large segment of the population. Thus, new advertising technology is needed to take greater advantage of such media.

### SUMMARY OF THE INVENTION

This invention provides a network assisted advertising system where a subscriber may coordinate advertising channels such as newspapers, magazines, radio, television, etc. together with one or more web pages of a network such as the Internet. The subscriber is provided tools in a web-based advertising system to construct a subscriber website that includes one or more subscriber web pages and given an access address (e.g. universal resource locator (URL)) for the subscriber website for use with other advertising channels. The access address is limited to be less than a predetermined number of characters so that it may be easily remembered by a prospective customer.

The subscriber web pages may include text and photographs so that detailed information may be provided to a prospective customer. Links to helpful websites may also be included to assist the prospective customer to make a purchase decision, for example.

The web-based advertising system also provides tools for the subscriber to maintain the subscriber website. For example, the subscriber may simulate the constructed subscriber website, add information such as more photographs or delete information.

The web-based advertising system may activate web page functions when a prospective customer accesses the subscriber website. Monitoring functions may also be provided so that both the prospective customer and the subscriber may receive helpful information. For example, information such as a number of offers and the highest offer price may be provided to the prospective customer, and the number of hits and any requests for appointments, purchase offers or feedback questions may be provided to the subscriber.

The web-based advertising system protects the subscriber from compromising an impact of the subscriber website by not providing prospective customers with a search tool that may search through other subscriber sites or websites supported by the web-based advertising system. In this way, subscriber investment into the subscriber website may not be diluted by distracting information from other subscribers, especially those other subscribers that offer information relating to similar objects or items advertised by the subscriber. Thus, the network assisted advertising system enables a subscriber to reduce the amount of information used in other advertising channels by providing a link between the other advertising channels and the subscriber website where detailed information may be deposited for viewing by any prospective customer. At the same time, the subscriber's investment is not diluted by information supplied by other subscribers.

### BRIEF DESCRIPTION OF THE DRAWINGS

The invention is described with reference to the following drawings wherein like numerals represent like elements, and wherein:

FIG. 1 shows an exemplary block diagram of the network assisted system;

FIG. 2 shows an exemplary block diagram of a web-based advertising system;

FIG. 3 shows an exemplary block diagram of a subscriber web interface;

FIG. 4 show an exemplary web page of a new subscriber interface;

FIG. 5 shows an exemplary block diagram of a subscriber web page;

FIG. 6 shows an exemplary subscriber web page;

FIG. 7 shows an exemplary subscriber web page template;

FIG. 8 shows an exemplary display of a web page layout editor;

FIG. 9 shows an exemplary web page for adding links to the subscriber web page;

FIG. 10 shows and exemplary web page of a web page monitor/maintenance interface;

FIG. 11 shows an exemplary block diagram of the web-based advertising system;

FIG. 12 shows a flow chart of an exemplary access request process of the web-based advertising system;

FIG. 13 shows a flow chart of an exemplary process of the web-based advertising system for constructing a subscriber website; and

FIG. 14 shows a flow chart of an exemplary process of the web-based advertising system for receiving an access request from a prospective customer.

### DETAILED DESCRIPTION OF PREFERRED EMBODIMENTS

Networks, such as the Internet, have become a very popular medium of communication. Many different techniques have been developed for advertising using networks such as searchable websites, displaying photographs of real estate, banners, etc. Thus, networks such as the Internet have become an important advertising channel among other traditional advertising channels such as newspapers, magazines, television, radio, etc. This invention provides an advertising system that integrates multiple advertising channels to take advantage of strengths of each advertising channel while protecting the advertising investment of an advertiser.

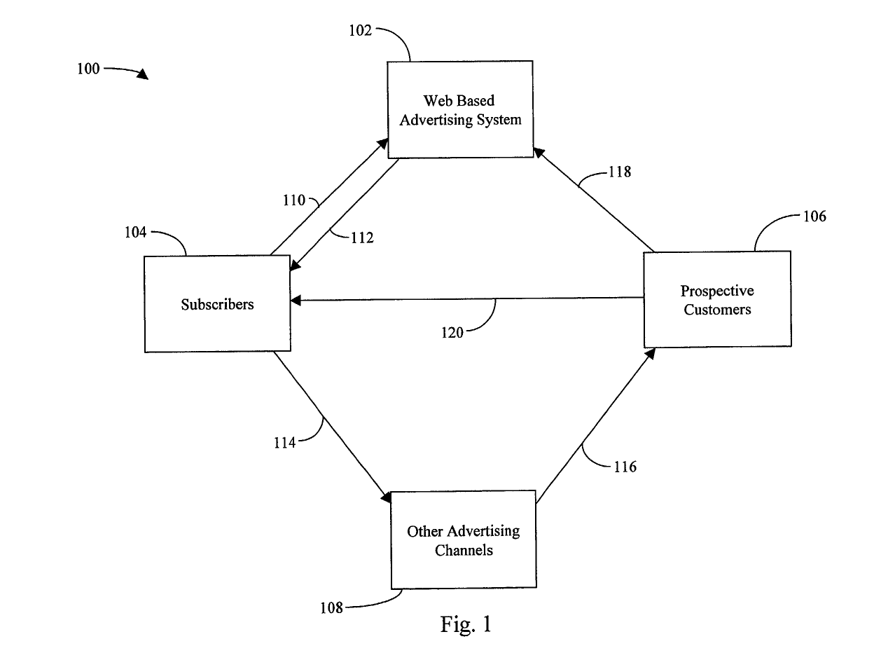

FIG. 1 shows an exemplary diagram for a network assisted advertising system 100. The network assisted advertising system 100 may include a web-based advertising system 102, subscribers 104, prospective customers 106 and other advertising channels 108. The subscribers 104 may engage with the web-based advertising system 102 to build a subscriber website that includes one or more web pages (link 110) having information regarding objects or items that the subscribers 104 desire to advertise. The information may include text, graphics or photographs relating to the objects or items that are being advertised.

For example, if a subscriber 104 desires to advertise a motor home, the web pages may include photographs of the motor home with captions describing each of the photographs. Additionally, other information such as maintenance history, vehicle type, etc., may also be included in the subscriber web pages. The subscriber web pages may provide links to other helpful websites for information such as consumer pricing guides, financing options from lenders, product reviews and ratings. The subscriber web pages may also include contact information either to the subscriber 104 or to an agent of the subscriber 104 so that prospective customers 106 may proceed with purchasing the vehicle. For example, when an actual test drive is desired, the prospective customer 106 may contact the subscriber 104 (link 120) to arrange for an appointment.

While the above example uses a motor home, other objects or items may also be described by the subscriber web pages such as cars, boats, real estate, commercial and/or industrial equipment, etc. Corporations may use the network assisted advertising system 100 as a standard advertising technique for commercial transactions. Also, while in the above description, the subscriber 104 builds the subscriber website (which may include one or more web pages), the subscriber website may be built by the web-based advertising system 102 either automatically or manually as a service option, or by anyone else chosen by the subscriber 104.

After the subscriber website is completed, the web-based advertising system 102 may provide the subscriber 104 (link 112) with an access address (e.g., universal resource locator (URL)) to the subscriber website. The access address may be limited to less than a predetermined number of characters so that the subscriber 104 may conveniently use the access address to advertise the object or item using other advertising channels 108.

When used, the access address provides access only to the subscriber website and any links that the subscriber 104 has chosen to include in the subscriber website. Thus, when accessing the subscriber website, a prospective customer 106 is prevented from viewing subscriber websites of other subscribers 104. In this way, subscriber's advertising investment is not diluted by distracting a prospective customer 106 with advertising information of other subscribers 104.

As mentioned above, the subscriber 104 may use the access address of the subscriber website in many other advertising channels 108. For example, if a motor home is being advertised, the subscriber 104 may list the motor home in a classified ad of a newspaper and include the access address of the subscriber website in the classified ad. When attracted by the classified ad (link 116), a prospective customer 106 may access the subscriber website (link 118) by using the access address. In this way, the subscriber 104 may provide more detailed information to the prospective customer 106 without expending a large amount of advertising dollars in the other advertising channels 108. For example, taking out a full page ad in a newspaper may be cost prohibitive. However, using the access address, the subscriber 104 may expend only a small cost for advertising in the newspaper and yet still provide detailed and attractive information to prospective customers 106.

The other advertising channels 108 may include any advertising media. For example, the subscriber 104 may use the access address as part of a television or radio advertising campaign, magazines, professional journals, billboards, vehicle side panels of trucks, etc. The subscriber 104 may optimize advertising impact while minimizing costs by minimizing the amount of information used in the other advertising channels 108. The needed detailed information may be provided using subscriber web pages of the network assisted advertising system 100. In this way, the subscriber 104 may have more funds available for a larger number of advertisements.

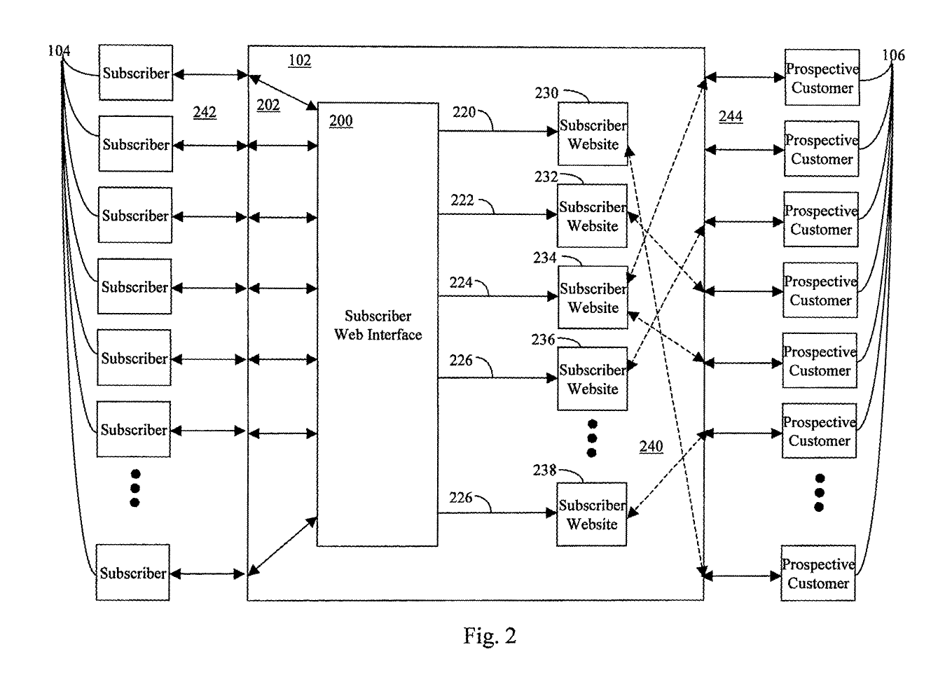

FIG. 2 shows the web-based advertising system 102 in greater detail. The web-based advertising system 102 may include a subscriber web interface 200 and one or more subscriber websites 230-238. Subscribers 104 interface with the subscriber web interface 200 via links 242 and 202. The links 242 represents network accesses (e.g., Internet access) by the subscribers 104 to the web-based advertising system 102. Each of the subscribers 104 may individually access the subscriber web interface 200 via the links 202.

The subscriber web interface 200 provides tools and help facilities to assist the subscriber 104 to construct subscriber websites 230-238. Once constructed, the subscriber websites 230-238 may be accessible to prospective customers 106 via links 244 and 240. The links 244 represent network access (e.g., Internet access) of each of the prospective customers 106. The links 240 represent subscriber website access provided by the web-based advertising system 102. Each of the components of the web-based advertising system 102 are described in detail below.

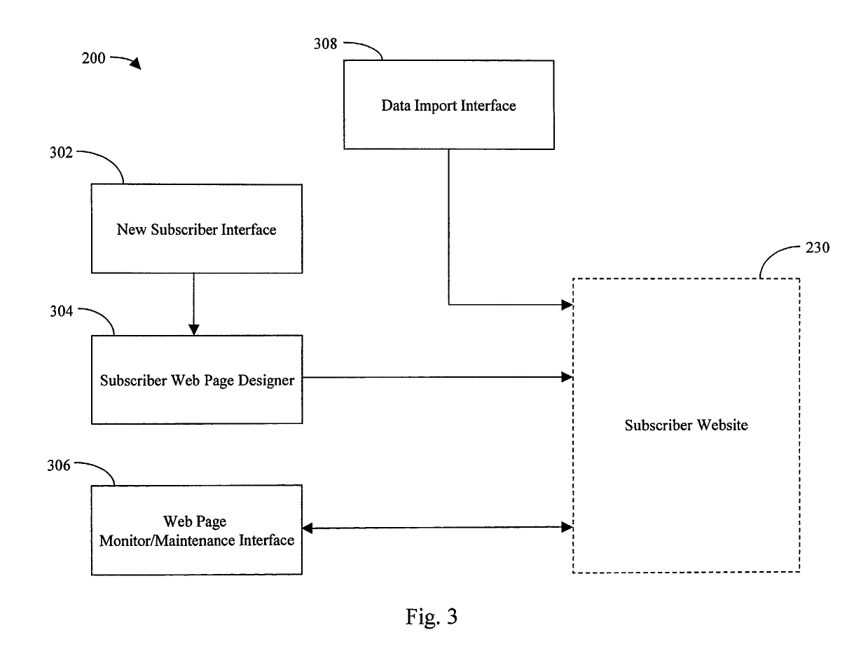

FIG. 3 shows an exemplary block diagram of the subscriber web interface 200 which may include a new subscriber interface 302, a subscriber web page designer 304, a web page monitor/maintenance interface 306 and a data import interface 308. The new subscriber interface 302 provides web pages, for example, to anyone who accesses the web-based advertising system 102. For example, the network assisted advertising system 100 may advertise itself via a network such as the Internet or the other advertising channels 108, for example. When a respondent (a potential new subscriber) to the advertisement accesses the web-based advertising system 102, the new subscriber interface 302 is activated to interface with the interested parties by providing web pages of a web-based advertising system website, for example.

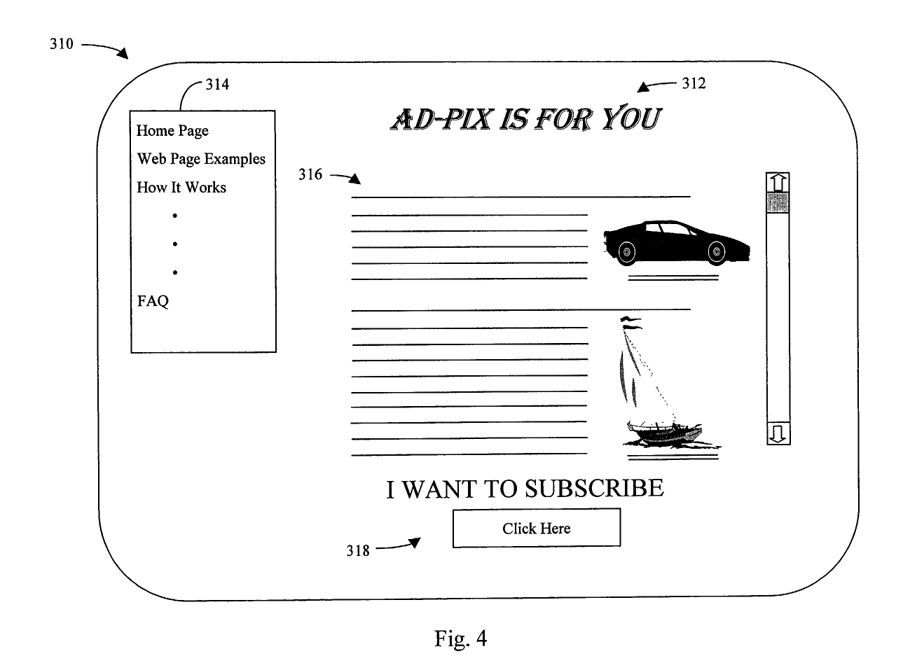

FIG. 4 shows an exemplary web page 310 that may be provided by the new subscriber interface 302. The web page 310 may include a web-based advertising system logo 312, an index of web pages 314, description text and Figures 316 discussing the benefits and functions of the web-based advertising system 102, an invitation to subscribe 318, etc. A potential new subscriber to the network assisted advertising system advertisement may peruse the web page 310 and/or other pages via the web page index 314 to become informed of the advantages and benefits of the web-based advertising system 102. Examples of subscriber web pages, lists of questions and answers relating to how the network assisted advertising system 100 works, etc. If the potential new subscriber desires to subscribe to the network assisted advertising system 100, then the invitation to subscribe 318 is selected and a web page is displayed that invites the now new subscriber 104 to enter personal information such as name, address, etc., and billing information such as credit card number, payment methods, etc. After the preliminary subscription process is completed, the new subscriber 104 may begin designing subscriber web pages by using the tools and facilities provided by the web-based advertising system 102. The new subscriber 104 may choose to immediately engage in web page design or may delay such action until a later more convenient time.

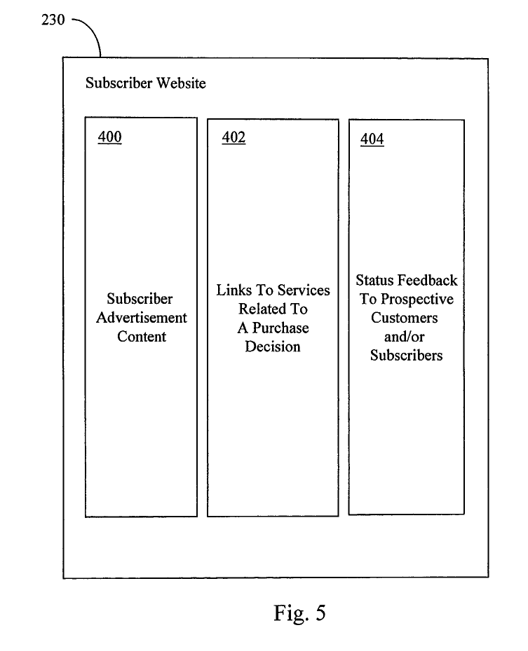

FIG. 5 shows an exemplary block diagram of the subscriber website 230 which may include portions 400-404. The portion 400 includes subscriber advertisement content; the portion 402 includes links to other services; and the portion 404 relates to status/feedback to prospective customers and/or the subscriber 104. Each of these subscriber web page portions 400-404 are discussed in detail below.

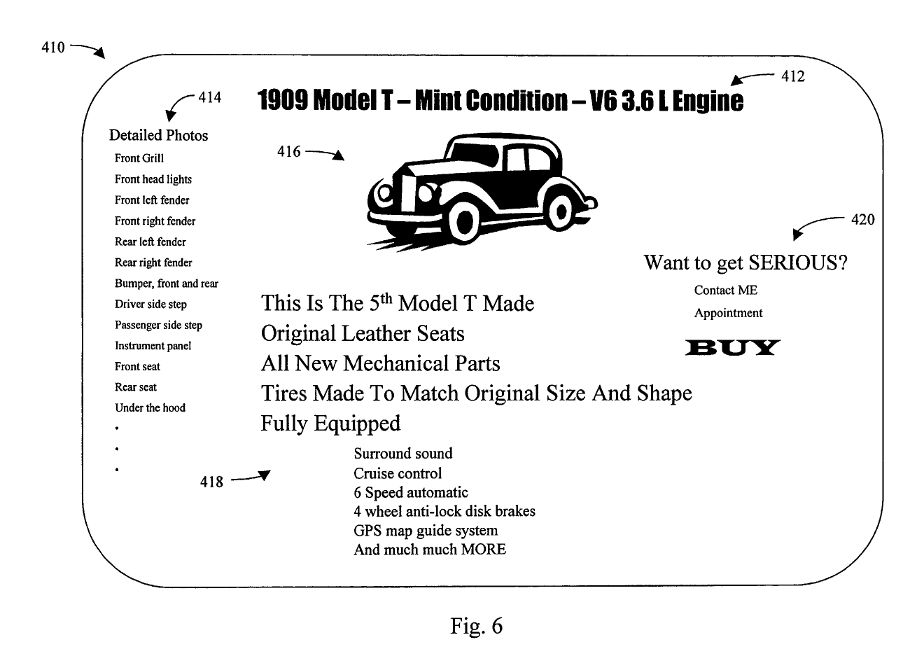

FIG. 6 shows an example of a subscriber web page 410. The subscriber web page may include a title 412, an index of photos 414, a main picture 416, a feature summary 418 and links 420. The subscriber 104 may personalize each of the above portions of the subscriber web page 410.

The web-based advertising system 102 may provide tools to help the subscriber to construct a web page such as the web page 410. The web-based advertising system 102 may provide templates to guide the subscriber 104 in formatting and filling the subscriber web page with relevant content.

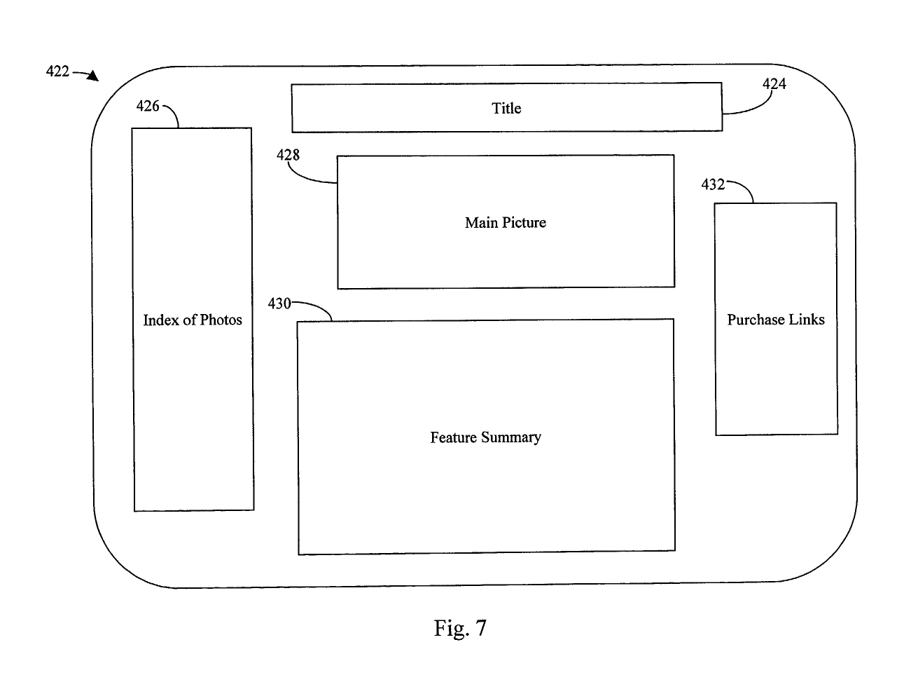

For example, FIG. 7 shows a subscriber web page template 422 that may correspond to the subscriber web page 410 as shown in FIG. 6. The subscriber web page template 422 may include boxes with a label indicating the appropriate content for each box. For example, the subscriber web page template 422 may include a title box 424, an index of photographs box 426, a main picture box 428, a feature summary box 430 and a links box 432.

When the subscriber 104 clicks each of the above boxes, for example with a mouse, a new window is opened for the subscriber 104 to enter the appropriate information. Within each of the windows, examples may be given to provide the subscriber 104 with ideas on what to enter for each of the respective boxes 424-432. For example, the web-based advertising system 102 may provide a compilation of titles that may be used. Thus, when the subscriber 104 clicks on the box 424, an index of possible titles organized based on object or item category may be provided. The subscriber 104 may peruse through the sample titles and may select one of the titles and modify the selected title as desired.

While the boxes 426 and 428 require pictures or photographs of the object or item that is being described, the subscriber 104 does not need photographs or graphic illustrations to proceed with the subscriber website construction. Placeholders may be used in place of the photographs until the actual photographs are available. For example, the web-based advertising system 102 may provide clip art graphics indexed by category so that the subscriber 104 may select one of the clip arts to represent the photograph that eventually will be provided. The subscriber 104 may create any number of photograph placeholders, limited only by cost, to properly represent the object or item being described. As each of the photographs is being defined, the web-based advertising system 102 may prompt the subscriber 104 to provide a photograph caption so that a description of the photograph may be associated with each of the photographs.

In a similar way, the feature summary box 430 and the purchase links box 432 may be completed. The links box 432 is one way to implement the portion 404 and will be discussed in greater detail later. In this way, the subscriber 104 is not required to have web page building skills so that any subscriber 104 may easily construct a subscriber website without engaging in complex details of web page building languages, for example.

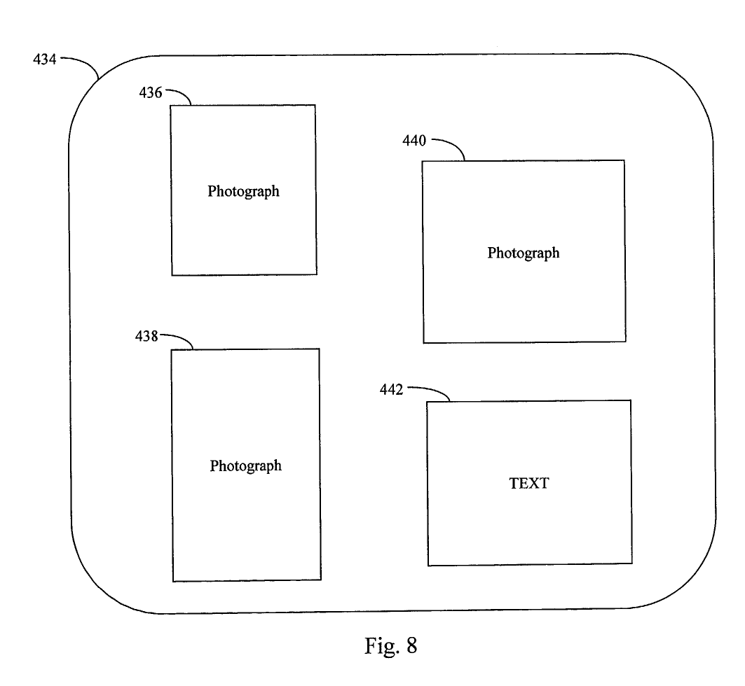

The web-based advertising system 102 may also provide other features that may assist the subscriber 104 to better format the subscriber web pages. For example, as shown in FIG. 8, the web-based advertising system 102 may provide web page layout editors that permits the subscriber 104 to combine multiple photographs and text information onto a single page. For example, the web page 434 shown in FIG. 8 includes photographs 436-440 and text information 442. Each of the photographs 436-440 may be individually placed, sized, and enhanced by adding special effects. While the text information 442 is shown in one box, multiple boxes may be introduced and placed in any position such as around or over the pictures and in any orientation, for example. In this way, the web-based advertising system 102 may assist the subscriber 104 to construct many different types of subscriber web pages so that attractive presentation of information may be easily accomplished.

The subscriber 104 may provide photographs to the web-based advertising system 102 in many different ways. For example, the subscriber 104 may upload digitized images of the photographs to the web-based advertising system 102 via the data import interface 308 of the subscriber web interface 200. The images may be provided in many different formats such as jpeg files, tiff files, bmp files, PDF files, GIF files etc. Depending on specific capabilities of the web-based advertising system 102 or the desires of the subscriber 104, digital images may be required to be placed in a specific format. The subscriber 104 may convert the images into the desired format using available tools. For example, the web-based advertising system 102 may provide conversion tools so that the subscriber 104 may convert the photographs as needed. In addition, the web-based advertising system 102 may also provide picture editing capabilities so that poor quality photographs may be enhanced and unattractive features may be eliminated.

The subscriber 104 may choose to send physical pictures to the network assisted advertising system 100 by available shipping methods such as mail, courier, drop off box, etc. In this case, the network assisted advertising system 100 will provide scanning services to scan the provided photographs into digital images and either incorporate the digital images into the subscriber website, or provide the digital images to the subscriber 104 for incorporation into the subscriber website.

The subscriber 104 may also send film to photograph developers to develop pictures for insertion into the subscriber web pages. In such a case, the subscriber 104 may request the film developer to provide the photographs either in physical form, digital form and/or on a photo compact disc (photo CD) to the network assisted advertising system 100. Thus, the subscriber 104 may provide the photographs to the network assisted-system 100 in any manner available so that digital images may be incorporated into the subscriber web pages.

The portion 402 of the subscriber website 230 provides links to other websites as may be desired by the subscriber 104. For example, links to lending institutions, price comparisons and/or other advertising media may be provided. When such links are desired, the subscriber 104 may select the add links option, for example. The subscriber website 230 may provide a separated web page that includes many possible links.

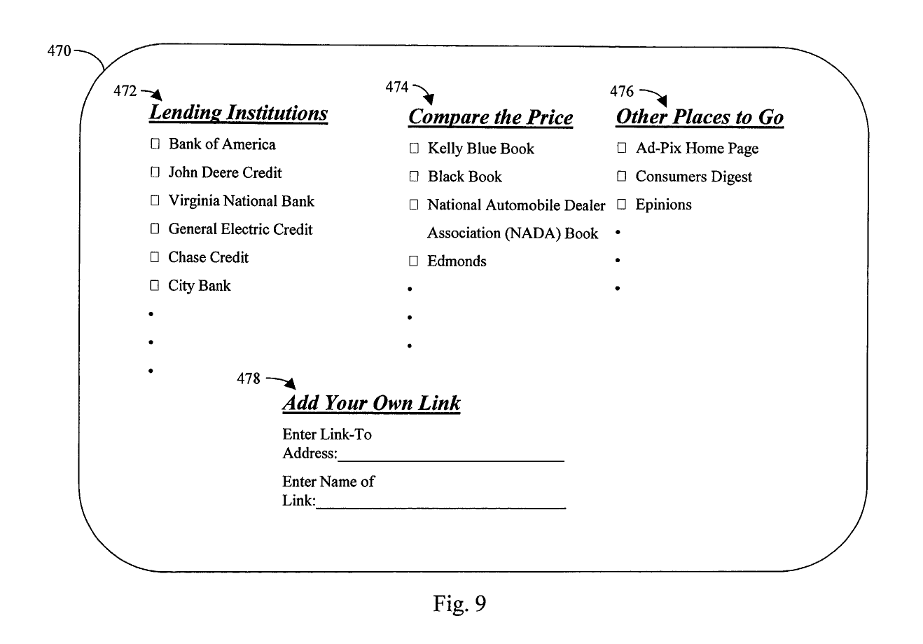

FIG. 9 shows an example of such a web page 470. The web page 470 may include possible links 472 to lending institutions, links 474 to organizations that provide price comparisons, and links 476 to other miscellaneous places such as ad-pix home page, Consumers Digest, etc.

The web page 470 may also provide a template 476 for the subscriber 104 to add personalized links to locations that are not found elsewhere in the websites 470. For example, the subscriber 104 may have constructed many subscriber web pages 230 and wishes to “advertise” the other subscriber websites 230 using the template 476. In this way, the subscriber 104 may create a network of links that links all the subscriber websites 230 together forming a network of websites.

The portion 402 may provide a template for a search engine that searches through all the subscriber websites 230 of the subscriber 104, or search through web pages or websites identified by the subscriber 104. Thus, the subscriber 104 may build a complete website for advertising the subscriber's own objects or items and/or objects or items of other subscribers 104 if desired.

The portion 404 of the subscriber website 230 may include information regarding the status of the advertised object or item. For example, status feedback information to a prospective customer 106 such as a number of appointments made by other interested prospective customers 106, a number of actual offers, a highest offered amount, and seller evaluation information provided by prior purchasers of items from the same subscriber 104.

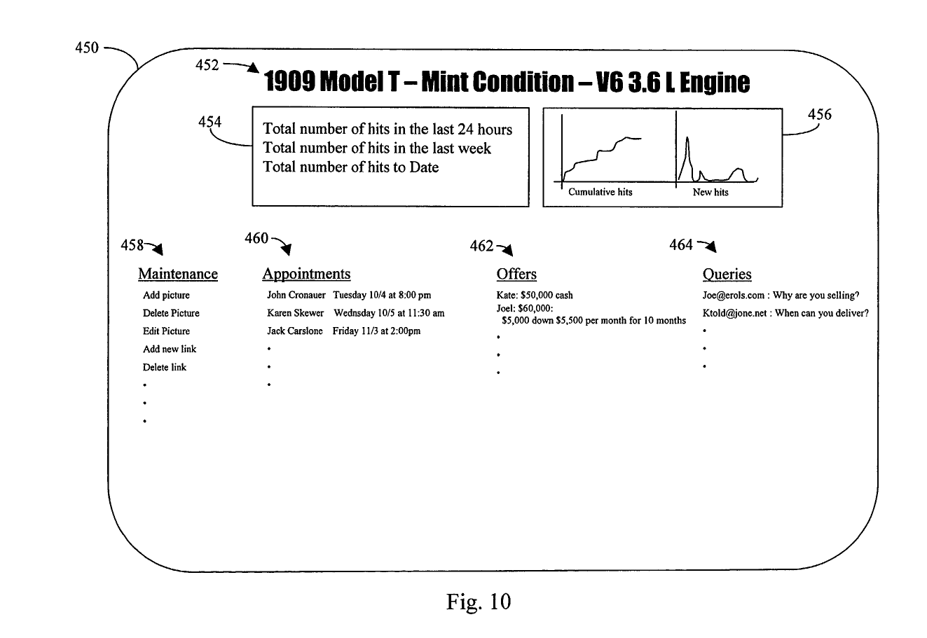

The web page monitor/maintenance interface 306 provides feedback information to the subscriber 104 as well as tools and/or facilities for the subscriber 104 to maintain the subscriber website 230. FIG. 10 shows an exemplary web page 450 that may be provided by the web page monitor/maintenance interface 306. The web page 450 may include a title 452 that is identical to the title of the subscriber website 230, a text statistics 454 that provides a summary of the number of hits received by the subscriber website 230 and a graphical representation 456 of the statistics. Other types of numerical information may also be provided in either textual or graphical form.

The web page 450 may also include maintenance and reporting features such as the maintenance index 458 that includes options that may be selected by the subscriber 104 to maintain the subscriber website 230. For example, the subscriber 104 may use the maintenance index 458 to add a new picture, delete a picture, edit a picture, add a new link, delete a new link, etc. Each of these features may provide the subscriber 104 with other web pages that includes tools to help the subscriber 104 maintain the subscriber website 230.

The web page 450 may provide monitoring features such as appointments 460, offers 462, inquiries 464 as shown in FIG. 10. The appointments 460 may report to the subscriber 104 prospective customers 106 that desire to make an appointment to view the object or item, for example. The offers 462 may provide the subscriber 104 with feedback for prospective customers 106 that would like to purchase the object or item and may include actual offers for purchase, rental, exchange, etc. The queries 464 provide a way for prospective customers 106 to ask the subscriber 104 questions to assist them in evaluating a decision.

If the subscriber 104 has constructed multiple subscriber websites 230, the subscriber 104 may maintain and monitor all the subscriber websites 230 using the same web page 450. In such a case, an index may be provided to the subscriber 104 to allow easy selection of information relating to any particular subscriber website 230.

While FIG. 10 shows the monitoring and feedback information being provided via the web page 450, the web page monitor/maintenance interface 306 may also format and send the information to the subscriber 104 via other communication media such as facsimile, voice mail, regular mail, e-mail, etc. The web page monitor/maintenance interface 306 may provide tools for the subscriber 104 to design a web page such as the web page 450 similar to the features provided by the subscriber web page designer 304 for designing the subscriber web page 410. In this way, the subscriber 104 is provided a comprehensive set of tools to design and maintain the subscriber website 230.

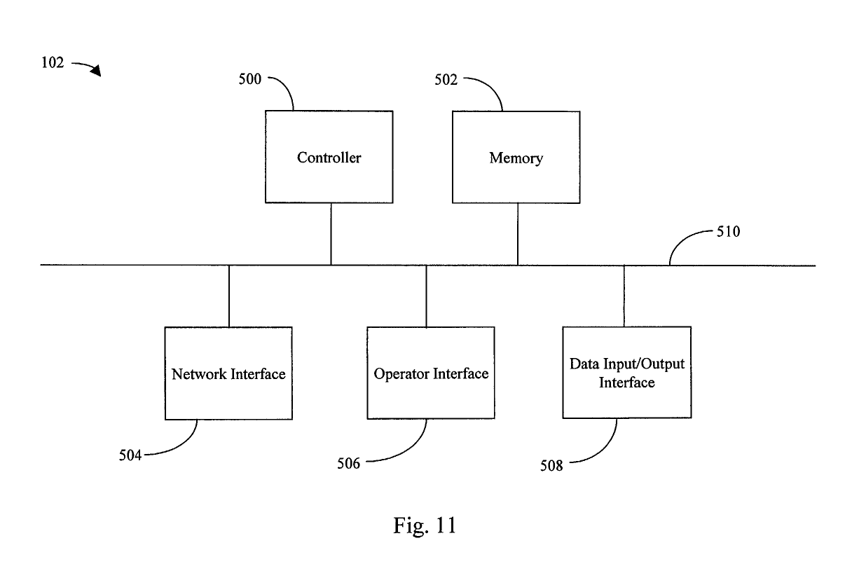

FIG. 11 shows an exemplary block diagram of the web-based advertising system 102. The web-based advertising system 102 may include a controller 500, a memory 502, a network interface 504, an operator interface 506 and a data input/output interface 508. The above components may be coupled together via bus 510. While FIG. 11 shows the web-based advertising system 102 in a bus architecture, other types of architecture may be used as is well known to one of ordinary skill in the art.

When a prospective new subscriber accesses the web-based advertising system 102, an access request may be received through the network interface 504. The access request is examined by the controller 500. An identification portion of the access request is extracted to determine whether the access request is received from a subscriber 104 or from a new prospective subscriber. If the access request is from a subscriber 104, then the controller 500 may perform security validation such as passwords, personal identification numbers (PIN), account numbers, etc.

After the security validation, the controller 500 may provide the subscriber 104 with an option web page. In the option web page, the subscriber 104 may choose to create a new subscriber website 230, or to access the web page monitor/maintenance interface 306 to maintain subscriber web page(s) which are already constructed. If the subscriber 104 desires to create a new subscriber website 230, the subscriber 104 may be linked to the subscriber website designer 304 for construction of a new subscriber website 230.

If the access request is received from a prospective new subscriber, the controller 500 links the prospective new subscriber to the new subscriber interface 302. The new subscriber interface 302 may display a web page such as the web page 310 to introduce the prospective new subscriber to the features and benefits of the network assisted advertising system 100. If the prospective new subscriber chooses to subscribe to the network assisted advertising system 100, then the controller 500 may interact with the new subscriber 104 to receive the personal information and account information. After such information is received, the new subscriber 104 is linked to the subscriber page web page designer 304 for possible construction of a new subscriber website 230.

When a subscriber 104 desires to construct a new subscriber website 230, the controller 500 interfaces with the subscriber 104 via the network interface 504 over a network (e.g., Internet) and prompt for entry of advertisement information. For example, the controller 500 may display a web page template such as the template 422 shown in FIG. 7 and invite the subscriber 104 to click on any one of the blocks 424-432 to begin constructing the new subscriber website 230. As mentioned earlier, when the subscriber 104 selects the block 424 for entry of a title, the controller 500 may provide examples such as a compiled list of title examples stored in the memory 502. The examples may be indexed by categories, so that the subscriber 104 may be assisted in selecting an appropriate title for the desired subscriber website 230.

When the subscriber 104 selects block 426, the controller 500 may output a query to request the subscriber 104 to select a method of importing the photographs into the web-based advertising system 102. If the subscriber 104 elects to upload the photographs, the controller 500 may receive the uploaded photographs via the network interface 504 and save the uploaded photographs in the memory 502 in connection with the new subscriber website 230. Before storing the uploaded photographs, the controller 500 may determine whether the uploaded photographs are in an acceptable format. If the acceptable format is used, then the photographs may be stored in the memory 502. However, if the uploaded photographs are not in the acceptable format, the controller 500 may inform the subscriber 104 that an acceptable format is needed. The subscriber 104 may convert the photographs into the acceptable format, or the controller 500 may offer to convert the photographs into the proper format for a fee.

The subscriber 104 may choose to either send hard copies of the photographs by mail, or have a photograph developer develop film and send developed photographs or photo CD(s) to the network assisted advertising system 100. The photograph developer also may transmit digital images directly to the network assisted advertising system 100. In this case, the controller 500 may provide photograph placeholders for the total number of photographs that are desired by the subscriber 104.

For example, the controller 500 may provide an index of possible placeholders to the subscriber 104 for selection as appropriate placeholders for each of the photographs. The placeholders may be graphical representations of various objects or items such as a car, a boat, a motor home, a house, a piece of equipment such as a complex computer, or icons of various types, etc. The controller 500 may provide an option for the subscriber 104 to upload appropriate graphics, for example. Additionally, the controller 500 may prompt the subscriber 104 to enter captions corresponding to each of the photographs. The captions may then be used as a placeholder until the actual photographs are loaded into the web-based advertising system 102.

As discussed above, the controller 500 may provide the subscriber 104 with various tools to compose the contents of a web page such as to place various photographs in different positions on a display and adding text block for description of the combination of photographs. While the above discussion uses photographs as an example, other types of video, video/audio, and/or multimedia information may be used (e.g., film clips, slide shows, etc.).

If photographs are to be received by mail, for example, the network assisted advertising system 100 may receive the photographs and/or photo CD(s). The photographs may be scanned or loaded from the photo CD(s) and entered into the web-based advertising system 102 via the data input/output interface 508. An operator of the web-based advertising system 102 may verify that the photographs are correctly received via the operator interface 506 and perhaps perform editing or conversion processes as may be required by the web-based advertising system 102. After the photographs are properly received into the web-based advertising system 102, the photographs are then placed into the subscriber website 230 as may be prescribed by the subscriber 104.

For example, the subscriber 104 may have marked the photographs (by writing on the back side of each photograph, for example), and designated a specific place in the subscriber web page. When the photographs are received from either the subscriber or a photograph developer, the operator or the controller 500 (if automatic photograph import is implemented) may scan the photograph identification and replace corresponding photograph placeholders with the actual photographs in the proper positions. If the subscriber 104 did not specifically identify the photographs, then the photographs are placed into a photograph file so that the subscriber 104 may place them into proper positions as may be desired.

After the photographs have been imported, the web-based advertising system 102 may inform the subscriber 104 of that fact either by e-mail via the network interface 504, or by other methods such as voice mail, facsimile, etc. In this way, the subscriber 104 may log-on to the web-based advertising system 102 to place the photographs in the subscriber website 230, and/or to view the photographs to assess their acceptability.

After the subscriber 104 has completed building the subscriber website 230, the controller 500 may simulate the subscriber website 230 so that the subscriber 104 may confirm operational integrity of the subscriber the website 230. For example, the controller 500 may display the subscriber web pages to the subscriber 104 as if the subscriber 104 is a prospective customer 106. The controller 500 may respond to various actions by the subscriber 104 as dictated by the subscriber website 230 so that functional paths such as links are tested.

After the subscriber website 230 is completed, the controller 500 may generate an access address for the subscriber website 230. For example, if the subscriber website 230 is provided on the Internet, a URL may be provided to the subscriber 104. The URL may be limited to be less than a predetermined number of characters so that extremely long URLs are not generated. Such long URLs are inconvenient to remember and use for the other advertising channels 108 and may incur additional costs for the large number of characters. For example, the URL may be limited to be less than 22 characters and may take on the form “www.ad-pix.com/xxxxxx” where xxxxxx may be a unique identification for a particular subscriber website 230.

When a prospective customer 106 enters an access address such as a URL using a browser, for example, the prospective customer 106 may be taken directly to a corresponding subscriber website 230. When an access request for a subscriber website 230 is received via the network interface 504, the controller 500 may first verify whether the selected subscriber website 230 is still active. The subscriber website 230 may not be active because the advertised item may have been sold, for example. If the subscriber website 230 is not active, the controller 500 may send a message to the prospective customer 106 to indicate that the requested subscriber website 230 is no longer active and may provide a reason for such inactivity.

If the subscriber website 230 is active, the controller 500 may link the prospective customer 106 to the subscriber website 230 and provide full functionality of the subscriber website 230 as constructed by the subscriber 104. The controller 500 does not provide the prospective customer 106 any capability for accessing subscriber websites 230 of other subscribers 104. In this way, the web-based advertising system 102 protects the advertising investment of each of the subscribers 104 by not diluting a subscribers website 230 with other subscriber websites 230.

The web-based advertising system 102 does not provide any tools or facilities that permit competition between subscriber websites 230. However, the controller 500 does not prevent prospective customers 106 from accessing more than one access address. If the prospective customer 106 accesses the web-based advertising system 102 using two or more access addresses (e.g., URLs), then the controller 500 accesses the corresponding subscriber websites 230 accordingly. Thus, prospective customers 106 may discover multiple advertisements via other advertising channels 108 and may log-on to the respective subscriber websites 230 to obtain additional information.

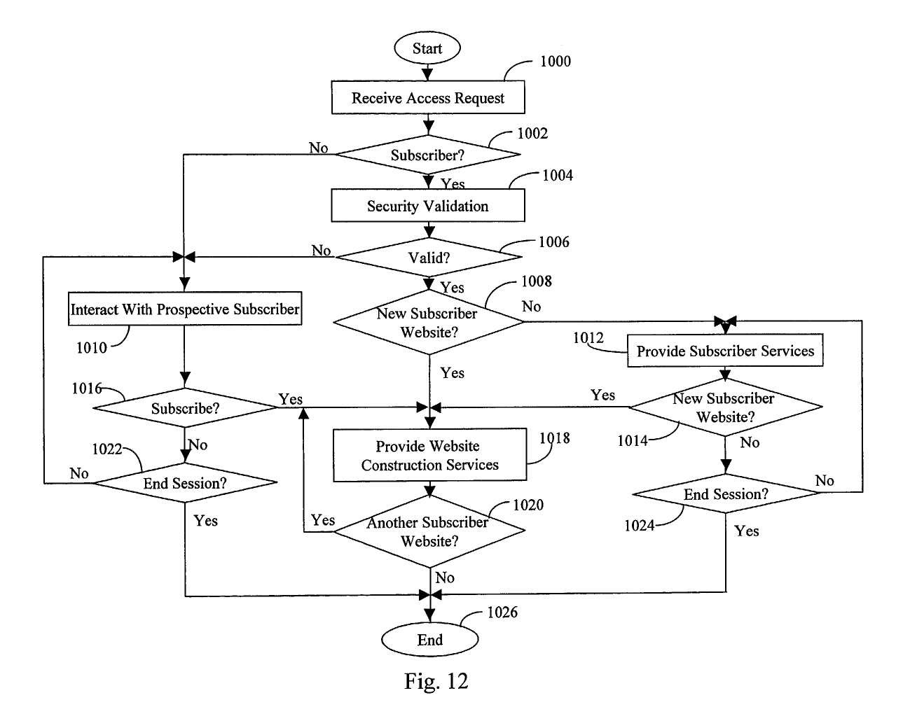

FIG. 12 shows a flowchart for an exemplary process of the web-based advertising system 102 for processing an access request from a subscriber 104 or a prospective new subscriber. In step 1000, the controller 500 receives the access request and goes to step 1002. In step 1002, the controller 500 determines whether the access request is received from a subscriber 104 or a prospective new subscriber. If a subscriber 104, then the controller 500 goes to step 1004; otherwise, the controller 500 goes to step 1010.

In step 1010, the controller 500 interacts with the prospective new subscriber using a web page such as the web page 310 shown in FIG. 4. Then the controller 500 goes to step 1016. In step 1016, the controller 500 queries whether the prospective new subscriber has elected to subscribe to the network assisted system 100. If elected, the controller 500 goes to step 1018; otherwise, the controller 500 goes to step 1022. In step 1022, the controller 500 determines whether the prospective new subscriber has ended the session. If the session has ended, the controller 500 goes to step 1026 and ends the process; otherwise, the controller 500 returns to step 1010.

In step 1004, the controller 500 performs security validation of the subscriber 104 and goes to step 1006. In step 1006, the controller 500 determines whether the access request was received from a valid subscriber 104. If valid, the controller 500 goes to step 1008; otherwise, the controller 500 goes to step 1010.

In step 1008, the controller 500 queries whether the subscriber 104 would like to create a new subscriber website 230. If a new subscriber website 230 is desired, the controller 500 goes to step 1018; otherwise, the controller 500 goes to step 1012. In step 1012, the controller 500 provides subscriber services such as linking to the web page monitor/maintenance interface 306 and goes to step 1014. In step 1014, the controller 500 determines whether the subscriber 104 desires to generate a new subscriber website 230. If a new subscriber web page is desired, the controller 500 goes to step 1018; otherwise, the controller 500 goes to step 1024. In step 1024, the controller 500 determines whether the subscriber 104 would like to end the session. If the subscriber 104 desires to end the session, the controller 500 goes to step 1026; otherwise, the controller 500 returns to step 1012.

In step 1018, the controller 500 provides web page construction services by linking to the subscriber web page designer 304, for example, and goes to step 1020. In step 1020, the controller 500 queries whether the subscriber 104 would like to construct another subscriber website 230 for a different advertisement. If a new subscriber website 230 is desired, the controller 500 returns to step 1018; otherwise, the controller 500 goes to step 1026 and ends the process.

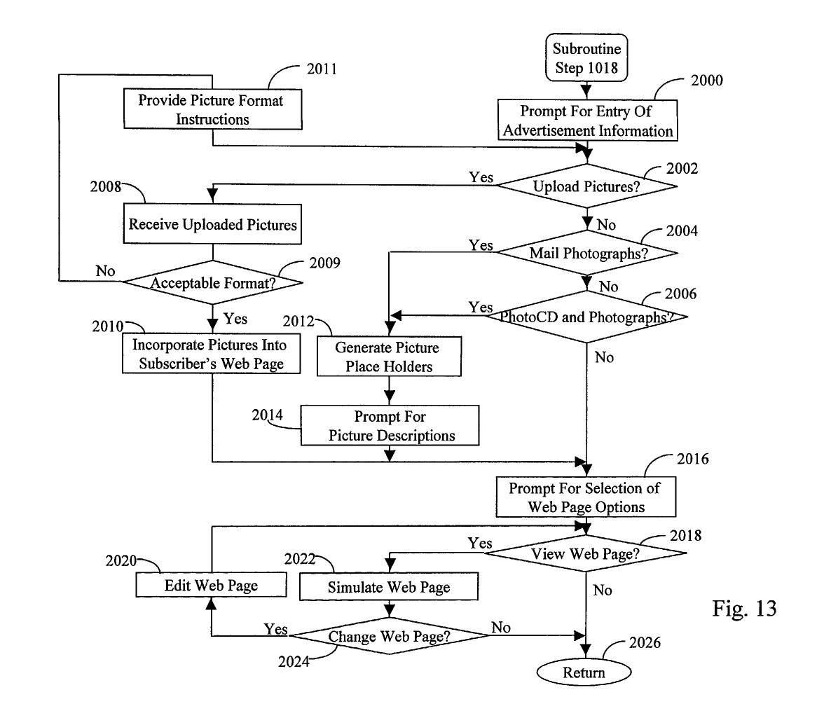

FIG. 13 shows the step 1018 in greater detail. In step 2000, the controller 500 prompts the subscriber 104 for entry of advertisement information. For example, the controller 500 may link the subscriber 104 to a web page template such as the web page template 422 as shown in FIG. 7. Then the controller 500 goes to step 2002. In step 2002, the controller 500 queries whether the subscriber 104 desires to upload pictures. If the subscriber 104 desires to upload pictures, the controller 500 goes to step 2008; otherwise, the controller 500 goes to step 2004.

In step 2008, the controller 500 receives the uploaded pictures and goes to step 2009. In step 2009, the controller 500 determines whether the received pictures are in the acceptable format. If the format is acceptable, the controller 500 goes to step 2010; otherwise, the controller 500 goes to step 2011. In step 2011, the controller 500 provides picture format instructions and returns to step 2002. The picture format instruction may instruct the subscriber 104 regarding the acceptable formats that are required for the functions that the subscriber 104 has selected. The controller 500 may also offer conversion services in which case the uploaded pictures may be placed into the acceptable format by the web-based advertising system 102. After such automatic conversion, the controller 500 goes to step 2010. In step 2010, the controller 500 incorporates the pictures into the subscribers website 230 and goes to step 2016.

In step 2004, the controller 500 queries whether the subscriber 104 would like to mail the photographs to the network assisted advertising system 100. If the subscriber 104 elects to mail the photographs, the controller 500 goes to step 2012; otherwise, the controller 500 goes to step 2006. In step 2006, the controller 500 queries whether the subscriber 104 desires to send film to one or more photograph developers and have the photograph developers send digital images, the photographs and/or photo CD(s) to the network assisted advertising system 100. If the subscriber 104 desires to send film to the photograph developers, the controller 500 goes to step 2012; otherwise, the controller 500 goes to step 2006 and assumes that no pictures are desired.

In step 2012, the controller 500 generates picture placeholders and goes to step 2014. As discussed earlier, the picture placeholders may be selected by the subscriber 104 from possible placeholders provided by the controller 500. In step 2014, the controller 500 prompts the subscriber 104 for picture descriptions or captions and goes to step 2016.

In step 2016, the controller 500 may prompt the subscriber 104 for various web page options and goes to step 2018. The web page template 422 provides an example of various web page options which may include entries for the title, purchase links, feature summary, etc. In step 2018, the controller 500 queries whether the subscriber 104 would like to view the subscriber website 230 that was just constructed. If the subscriber 104 would like to view the subscriber website 230, the controller 500 goes to step 2022; otherwise, the controller 500 goes to step 2026 and returns to the calling routine.

In step 2022, the controller 500 simulates the subscriber website 230 for the subscriber 104 and goes to step 2024. In step 2024, the controller 500 queries the subscriber 104 whether the subscriber 104 would to change the subscriber website 230. If the subscriber 104 would like to change the subscriber website 230, the controller 500 goes to step 2020; otherwise, the controller 500 goes to step 2026 and returns to the calling routine. In step 2020, the controller 500 links the subscriber 104 to a web page editing page that may provide various editors for the web page and goes to step 2018.

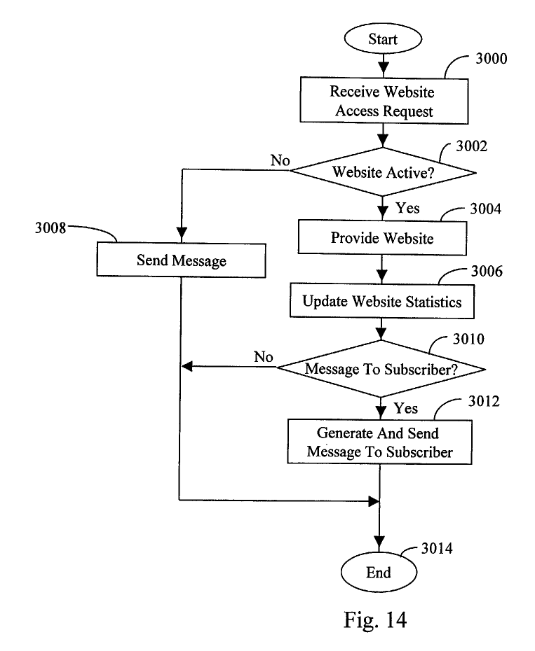

FIG. 14 shows a flowchart for an exemplary process of the web-based advertising system 102 for responding to an access request from a prospective customer 106. In step 3000, the controller 500 receives a web page access request and goes to step 3002. In step 3002, the controller 500 determines whether the accessed subscriber website 230 is still active. If active, the controller 500 goes to step 3004; otherwise, the controller 500 goes to step 3008. In step 3008, the controller 500 sends a message to the prospective customer 106 and may indicate the reason why the subscriber website 230 is no longer active and goes to step 3014 and ends the process.

In step 3004, the controller 500 provides the accessed subscriber website 230 to the prospective customer 106 and goes to step 3006. In step 3006, the controller 500 updates the subscriber website statistics such as a number of hits, any offers, requests for appointment or questions, for example, and goes to step 3010. In step 3010, the controller 500 determines whether there are any messages to be sent to the subscriber 104. If messages are to be sent to the subscriber, the controller 500 goes to step 3012; otherwise, the controller 500 goes to step 3014 and ends the process. In step 3012, the controller 500 generates and sends one or more messages to the subscriber 104. The messages may be in the form of e-mail, voice mail, facsimile, one or more entries in a monitor/maintenance web page such as the web page 450 as shown in FIG. 10. Then the controller 500 goes to step 3014 and ends the process.

While this invention has been described in conjunction with specific embodiments thereof, it is evident that many alternatives, modifications and variations will be apparent to those skilled in the art. Accordingly, preferred embodiments of the invention as set forth herein are intended to be illustrative, not limiting. Various changes may be made without departing from the spirit and scope of the invention.

What is claimed is:

1. A method for advertising an object of a subscriber, comprising:
providing a first website;
generating a second website using the first website, the second website including advertising information of the object;
generating an access address for the second website, the access address having less than a predetermined number of characters; and
providing the access address to the subscriber for advertising the second website.

2. The method of claim 1, further comprising:
advertising the object using the access address in one or more advertising media;
receiving access requests from prospective customers for the second website; and
interacting with the prospective customers.

3. The method of claim 2, further comprising:
receiving feedback information including one or more offers, request for appointment, and questions for the prospective customer; and
providing the feedback information to the subscriber.

4. The method of claim 1, further comprising:
monitoring the second website; and
reporting information relating to the second website to the subscriber.

5. The method of claim 1, first and second websites are on the Internet and the access address being a universal resource locator (URL).

6. The method of claim 5, the URL having less than 22 characters.

7. A method for advertising an object of a subscriber, comprising:
providing tools for the subscriber to generate a subscriber website that includes one or more subscriber web pages, the tools not providing, without a subscriber's request, any features for identifying another subscriber website;
generating an address for the subscriber website; and
providing access to the subscriber website based on the address.

8. The method of claim 7, the address having less than a predetermined number of characters.

9. The method of claim 7, further comprising:
providing the subscriber with one or more web page templates;
providing designated areas within each of the page templates; and
providing assistance relevant to a designated area when the designated area is selected.

10. The method of claim 9, further comprising:
providing a designated area for incorporating one or more photographs into a web page;
generating one or more placeholders for the photographs if the photographs are not available; and
prompting the subscriber for captions associated with each of the photographs and/or placeholders.

11. The method of claim 10, further comprising:
receiving photographs from the subscriber in a form of one or more:
one or more uploads of digital image data;
one or more hard copies; and
one or more photo CDs.

12. The method of claim 10, further comprising:
scanning the hard copies to generate digital images of corresponding one or more photographs.

13. The method of claim 10, further comprising:
confirming whether uploaded digital image data is in an acceptable format; and
if in a unacceptable format is detected, one of converting the digital image data into the acceptable format, and rejecting the uploaded digital image data and sending a message to the subscriber to place the digital image data in the acceptable format.

14. The method of claim 9, further comprising:
providing a designated area for incorporating one or more links into a web page;
providing a list of suggested links when requested by the subscriber, the suggested links including links to one or more other advertising media; and
providing an add link feature for the subscriber to add any desired link.

15. The method of claim 9, the designated areas including one or more of:
a title area;
a feature summary area;
an index area; and
a main picture area.

16. The method of claim 7, further comprising:
providing one or more maintenance web pages to the subscriber to maintain the subscriber website; and
modifying the subscriber website based on one or more instructions received through the maintenance web pages.

17. The method of claim 16, further comprising:
providing a feature for the subscriber to maintain one or more elements in the subscriber website, the feature including:
adding a new element deleting an element; and
editing an element, wherein an element includes one or more of a photograph and a link.

18. A method for operating a network assisted advertising service, comprising:
providing a first website;
providing tools in the first website for a subscriber to the network assisted advertising service to construct a second website, the second website including one or more web pages that:
present information regarding an object including one or more photographs, graphics and text, information relating to other second websites are not included unless requested by the subscriber,
provide links to one or more other websites desired by the subscriber, information relating to one or more links to one or more other second websites are not provided except when requested by the subscriber,
provide feedback information to the subscriber relating to the second website, and
provide maintenance tools for the subscriber to maintain the second website; and
generating an access address having less than a predetermined number of characters for the second website.

19. The method of claim 18, further comprising:
receiving an access request for the second website from a prospective customer;
providing access to the second website if the second website is active;
sending a message to the prospective customer if the second website is not active; and
collecting feedback information for the subscriber based on interaction with the prospective customer.

20. The method of claim 18, further comprising:
receiving an access request from the subscriber; and
performing security validation by checking security information received from the subscriber;
if security is confirmed, providing the subscriber access to one or more of:
the second website,
one or more maintenance and monitoring web pages, and
new second website construction web pages.
